(19) United States
(12) Patent Application Publication
(10) Pub. No.: US 2023/0172354 A1
(43) Pub. Date: Jun. 8, 2023

(54) MOVABLE COFFEE CAPSULE STORAGE RACK

(71) Applicant: Xiaofeng LIU, Foshan City (CN)

(72) Inventor: Xiaofeng LIU, Foshan City (CN)

(21) Appl. No.: 17/651,402

(22) Filed: Feb. 16, 2022

(30) Foreign Application Priority Data
Dec. 7, 2021 (CN) 202123059073.2

(51) Int. Cl. A47B 81/00; B65D 25/06; B60B 33/00

(52) U.S. Cl. CPC A47B 81/00; B65D 25/06; B60B 33/0002; A47B 2210/0008

(57) ABSTRACT

A movable coffee capsule storage rack includes a rack body for storage of coffee capsules. A first bracket is fixed to the bottom of the rack body, a first caster is rotatably connected to the first bracket through a first rotating shaft, a second bracket is disposed adjacent to the support leg, a second caster is connected to a second end of the second bracket, and when the second bracket is driven to rotate by the handle to drive the second caster to move down to hold up the support leg, the rack body is entirely supported by the first caster and the second caster and realizes free sliding. With the structure of the present disclosure, the storage rack is allowed to be switched quickly between the fixed state and the moving state through the movement of the second caster, the structure is simple, and the operation is convenient.

### CROSS REFERENCE TO RELATED APPLICATION

This application claims priority benefit of Chinese Patent Application No. 202123059073.2, filed on Dec. 7, 2021, and the entire contents of which are incorporated herein by reference.

### TECHNICAL FIELD

The present disclosure relates to the field of storage racks, in particular to a movable coffee capsule storage rack.

### BACKGROUND

As shown in FIG. 7 to FIG. 8, in the structure of a current coffee capsule storage rack 2, the storage rack 2 has two fixed first casters 7 on the ground at the rear end side, and two support legs fixedly disposed at the front end side 8. When the storage rack 2 is placed in a fixed state, through the friction between the support leg 8 and a desktop, the storage rack 2 can be placed on a decorative cabinet, a bar counter, the desktop or other bearing platforms stably without a large external force. When the storage rack 2 needs to be moved to adjust the position, a user can only lift the front end side of the storage rack 2 by hand to lift the support leg 8 off the ground, and with the first caster 7 as a support point, then the storage rack 2 is pushed to slide back and forth. If a larger number of coffee capsules are placed in a storage drawer, this operation mode will undoubtedly increase the burden on the user.

One of ways of using the current coffee capsule storage rack is: A cabinet 3 is installed on a wall 6, a wall cupboard 5 is disposed above a table top 301 of the cabinet 3, a capsule coffee machine 1 is placed above the coffee capsule storage rack 2, and the two are placed on the table top 301 of the cabinet 3 for use. A height L is defined between the table top 301 and the wall cupboard 5, which on the one hand can save space, and on the other hand facilitates the taking and placement of coffee capsules near the capsule coffee machine 1. However, limited by the height L, a top cover 4 on the top of the capsule coffee machine 1 cannot be fully opened when the storage rack 2 is in the fixed state, as shown in FIG. 8. Therefore, to fully open the cover 4, it needs to move the storage rack 2 as a whole, and pull out the capsule coffee machine 1 placed on the storage rack 2 at the same time to avoid the limitation of the height L. However, with only the structure of the first caster 7 and the support leg 8 above, the operation is very inconvenient, and even requires manual movement of the storage rack 2 and the capsule coffee machine 1, so the user experience is poor.

Furthermore, as described in a toy classification storage box in Chinese patent ZL202120153605.X, the bottom of a box body is provided with a sliding wheel, and the end of the bottom of the box body away from the sliding wheel is provided with a support base. The principle of use is basically the same as the above, and the difference is that this patent is a storage box for toys, and the subject of the present application is a storage rack for coffee capsules. The problem of this patent also lies in that the storage box cannot be pushed and pulled as a whole in the form of rollers, and it always needs to drag a handle to lift the support base off the ground and carry out movement through a set of sliding wheels, which is not convenient enough to use.

Furthermore, as described in a dust-proof transport device for jacket production in Chinese patent ZL201821268057.X, the part related to the problem to be solved in the present application is: rollers disposed at the bottom of the device can facilitate transportation, and the rollers can be folded at the same time for easy stacking of the device. This patent realizes the folding of the roller, and thus can be used in two different working conditions. However, since its folding structure or usage scene is different from the technical solution of the present disclosure, the descriptions thereof are omitted here.

Therefore, it is necessary to make further improvements to the current storage racks.

### SUMMARY

The present disclosure aims to solve the existing problems above, and provide a movable coffee capsule storage rack with a simple and reasonable structure, which mainly serves to allow the storage rack to be quickly switched between a fixed state and a moving state, and reduce the burden on the user's hands in the moving state.

A movable coffee capsule storage rack includes a rack body for storage of coffee capsules. A first bracket is fixed to the bottom of the rack body, a first caster is rotatably connected to the first bracket through a first rotating shaft, a support leg is fixedly connected to the bottom of the rack body, the first caster and the support leg are disposed at an interval in the front and rear, for supporting and fixing the rack body, a second bracket is disposed adjacent to the support leg, a handle is disposed at a first end of the second bracket, a second caster is connected to a second end of the second bracket, the second bracket between the first end and the second end is rotatably connected to the rack body through a second rotating shaft, and when the second bracket is driven to rotate by the handle to drive the second caster to move down to hold up the support leg, the rack body is supported by the first caster and the second caster and realizes free sliding.

The objective of the present disclosure may also use the following technical solution:

A connecting rod is connected to the second end of the second bracket, and the second caster is connected to the connecting rod.

The left and right sides of the rack body each are provided with a second bracket and a second caster, and the second ends of the two second brackets are coupled by the connecting rod, such that the two second brackets form a synchronous structure.

The first end of the second bracket is bent in an L shape to form the handle.

A connecting rod support plate is fixed to the connecting rod, and the second caster is rotatably connected to the connecting rod support plate.

A downswing limit block acting on the second bracket is installed on the rack body.

The bottom of the support leg is provided with an anti-skid pad.

Two first casters and two support legs are symmetrically disposed on the left and right sides of the rack body.

The rack body is also internally provided with a storage drawer, the left and right outer side walls of the storage drawer are provided with slide rails, and rollers slidably matched with the slide rails are correspondingly installed on the front end side of the rack body.

The rack body includes a frame bottom, a support and a panel placed on the support, the support leg, the first caster and the second bracket are installed on the frame bottom, the roller is rotatably connected to the support, and the material of the panel includes but not limited to transparent glass.

The present disclosure has the following beneficial effects:

(1) According to the movable coffee capsule storage rack of the present disclosure, the storage rack can be moved up and down through the second caster to be quickly switched between the fixed state and the moving state. In the moving state, the front end side of the storage rack can be supported by the second caster for storage, and in cooperation with the first caster, the storage rack can be easily moved as a whole, such that the storage rack is convenient to use.

(2) According to the movable coffee capsule storage rack of the present disclosure, even when a coffee machine is stacked on the storage rack for use, the storage rack can be slidably supported by the second caster and the first caster, and thus the storage rack and the coffee machine can be simultaneously moved as a whole, which also makes it easier for the user to put the coffee capsule in the coffee machine and remove a water tank on the coffee machine. The structure is simple and the operation is convenient.

### BRIEF DESCRIPTION OF THE DRAWINGS

FIG. 1 is a schematic structural diagram of a rack body of the present disclosure.

FIG. 2 is a schematic structural diagram of a fixed state in Embodiment 1 of the present disclosure.

FIG. 3 is a schematic structural diagram of a moving state in Embodiment 1 of the present disclosure.

FIG. 4 is a schematic structural diagram of a fixed state in Embodiment 2 of the present disclosure.

FIG. 5 is a schematic structural diagram of a moving state in Embodiment 2 of the present disclosure.

FIG. 6 is a schematic diagram of a rack body and a storage drawer of the present disclosure.

FIG. 7 is a schematic structural diagram of background art of the present disclosure.

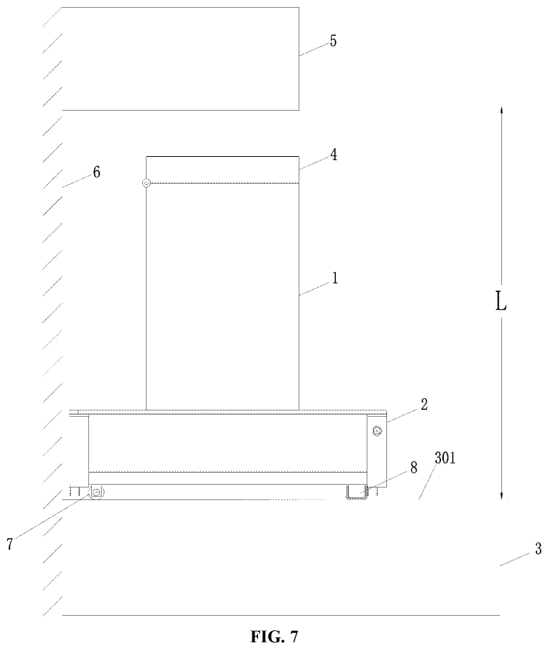

FIG. 8 is a schematic structural diagram of background art of the present disclosure.

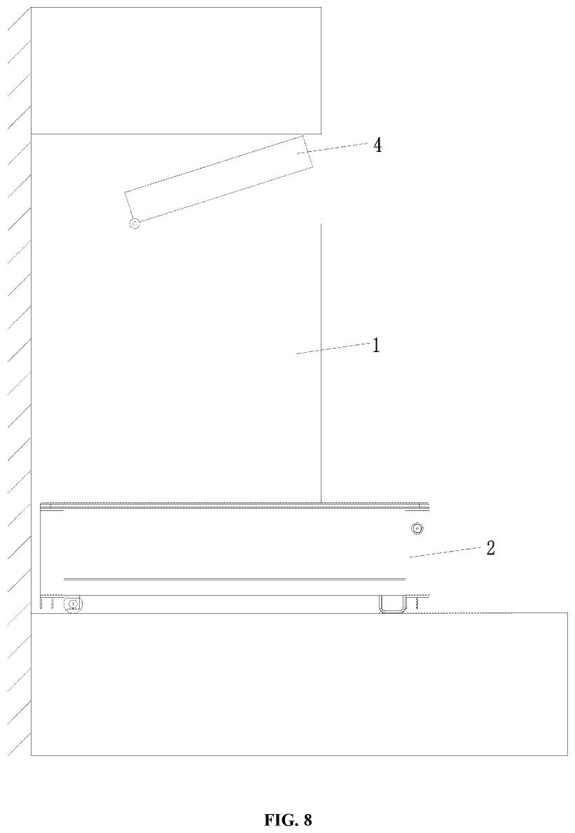

### DETAILED DESCRIPTION OF THE EMBODIMENTS

The present disclosure will be further described below in conjunction with the drawings and embodiments.

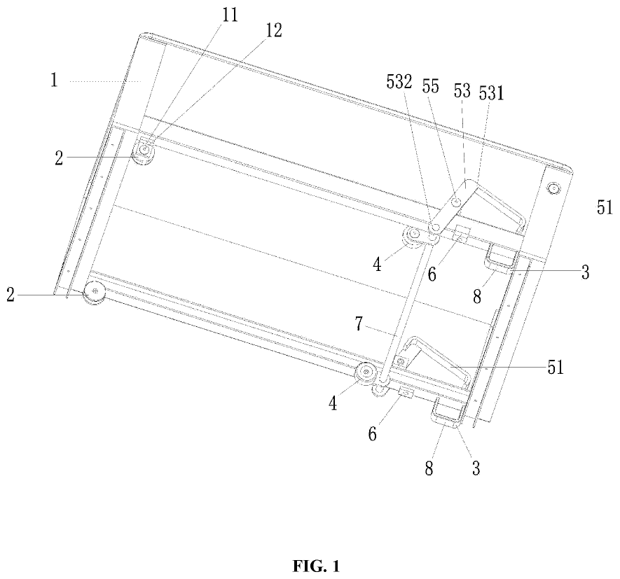

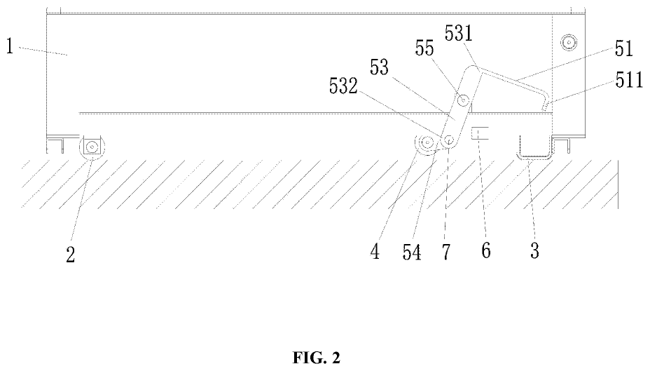

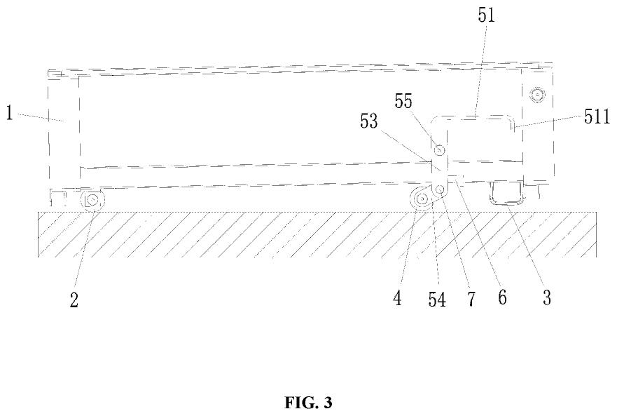

As shown in FIG. 1 to FIG. 3, Embodiment 1: a movable coffee capsule storage rack includes a rack body 1 for storage of coffee capsules, a first bracket 11 is fixed to the bottom of the rear end side of the rack body 1, a first caster 2 is rotatably connected to the first bracket 11 through a first rotating shaft 12, a support leg 3 is fixedly connected to the bottom of the front end side of the rack body 1, and the first caster 2 and the support leg 3 are disposed at an interval in the front and rear, for supporting and fixing the rack body 1. A second bracket 53 is disposed adjacent to the support leg 3, a handle 51 is disposed at a first end 531 of the second bracket 53, a second caster 4 is connected to a second end 532 of the second bracket 53, the second bracket 53 between the first end 531 and the second end 532 is rotatably connected to the rack body 1 through a second rotating shaft 55, and when the second bracket 53 is driven to rotate by the handle 51 to drive the second caster 4 to move down to hold up the support leg 3, the rack body 1 are entirely supported by the first caster 2 and the second caster 4 and realizes free sliding.

With this structure, the storage rack can be moved up and down through the second caster 4 to be quickly switched between the fixed state and the moving state. In the moving state, the front end side of the storage rack 4 can be supported by the second caster for storage, which can reduce the burden on user's hands.

In this embodiment, the left and right sides of the rack body 1 each are provided with a second bracket 53 and a second caster 4. The first end 531 of the second bracket 53 is bent in an L shape to form the handle 51. A connecting rod 7 is connected to the second end 532 of the second bracket 53, and the second caster 4 is connected to the connecting rod 7. The second ends 532 of the two second brackets 53 are coupled by the connecting rod 7, such that the two second brackets 53 form a synchronous structure. When the user operates with one hand, the second casters 4 on the left and right sides can swing synchronously by driving the handle 51 on one side. Moreover, a connecting rod support plate 54 is fixed to the connecting rod 7, the connecting rod support plate 54 and the second bracket 53 are opposed at different angles, the second caster 4 is rotatably connected to the connecting rod support plate 54, and as the user lifts and releases the handle 51, the second caster 4 is driven to swing up and down with the second shaft 55 as the axis.

In the structure above, double connecting rods (the second bracket 53 and the connecting rod support plate 54 in this embodiment) or multiple connecting rods are pivotally connected to the second caster 4. The double connecting rods or the multiple connecting rods adopts a relatively fixed hard connection. Only the second rotating shaft 55 is connected to the rack body 1 and forms a pivot point, without excessive mobile hinge points, which makes the structure for operating the second caster 4 by hand simpler and the power transmission is direct during operation.

In the fixed state, the rack body 1 is supported by the first caster 2 and the support leg 3, and can be placed stably through the friction between the support leg 3 and a bearing platform without a large external force, including that a coffee machine can be placed stably on the rack body 1.

When the fixed state is switched to the moving state, the user only needs to lift the handle 51 by hand to swing the second bracket 53 and the connecting rod support plate 54, thereby driving the second caster 4 to swing down. Under the lever principle, the user can easily drive the second caster 4 to swing down by lifting the handle 51, and hold up the support leg 3 to lift the support leg 3 off the ground. At this time, the rack body 1 is only supported by the second caster 4 and the first caster 2, such that the user can push and pull the rack body 1 to slide back and forth. If the coffee machine is placed on the rack body 1, the coffee machine can be moved along with the movement of the rack body 1, such that the user can open a top cover in a more suitable space state and put the coffee capsule into the coffee machine.

When the moving state is switched to the fixed state, the user only needs to press down the handle 51 to make the second caster 4 swing up for storage, such that the support leg 3 rests on the bearing platform again to achieve the fixed state, or the user only needs to leave the hand from the handle 51, and the automatic reset can be realized under the gravity of the storage rack itself.

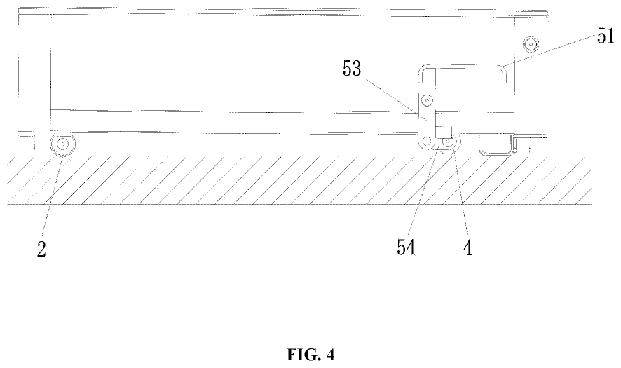

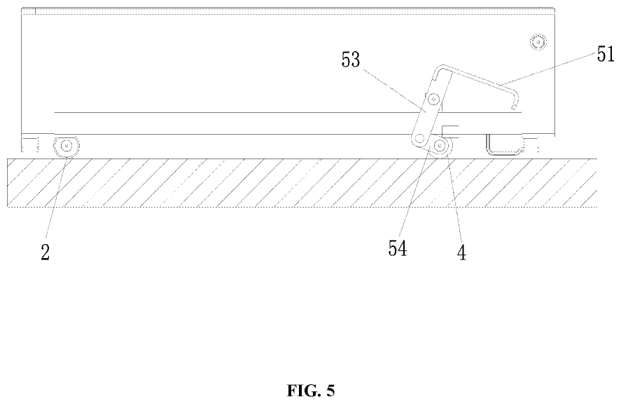

Embodiment 2: The structure of Embodiment 2 is basically the same as that of Embodiment 1, the difference is that in Embodiment 1, the second caster 4 is disposed on the side close to the first caster 2, while in Embodiment 2, as shown in FIG. 4 and FIG. 5, the disposing direction of the second caster 4 is opposite to that of Embodiment 1, the second caster 4 is disposed on the side close to the support leg 3, when the fixed state is switched to the moving state, the user presses down the handle 51 by hand to swing the second bracket 53 and the connecting rod support plate 54, thereby driving the second caster 4 to swing down, and when the moving state is switched to the fixed state, the user only needs to lift the handle by hand 51. The operation steps of Embodiment 2 are exactly opposite to those of Embodiment 1.

In the two embodiments above, the width of the handle 51 is extended along the left and right side directions of the rack body 1. This method allows the user to operate the handle 51 with a larger contact area, the pressure can be evenly distributed on the hand, and the operation feel is better. Moreover, the end of the handle 51 away from the second bracket 53 is provided with a turning portion 511, and the turning portion 511 serves to prevent the hand from falling off the handle 51.

Further, a downswing limit block 6 acting on the second bracket 53 is installed on the rack body 1, which can limit the downswing amplitude of the second caster 4.

Further, the bottom of the support leg 3 is provided with an anti-skid pad 8. The anti-skid pad 8 can increase the friction between the support leg 3 and the bearing platform, such that the storage rack will not be easily pushed and displaced when in the fixed state.

Further, two first casters 2 and two support legs 3 are symmetrically disposed on the left and right sides of the rack body 1, which allows the storage rack to be supported smoothly.

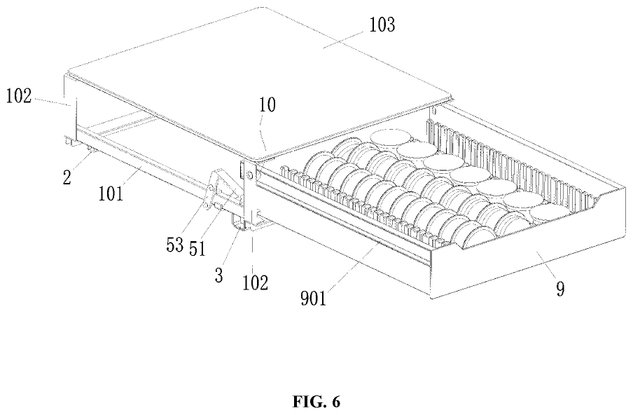

Further, as shown in FIG. 6, the rack body 1 is also internally provided with a storage drawer 9, the left and right outer side walls of the storage drawer 9 are provided with slide rails 901, and rollers 10 slidably matched with the slide rails 901 are correspondingly installed on the front end side of the rack body 1. The storage drawer 9 is used for storage of coffee capsules or other objects. Through the cooperation of the sliding rail 901 and the roller 10, the pushing and pulling processes are smoother.

Further, the rack body 1 includes a frame bottom 101, a support 102 and a panel 103 placed on the support 102. The support leg 3, the first caster 2 and the second bracket 53 are installed on the frame bottom 101. The roller 10 is rotatably connected to the support 102, and the material of the panel 103 includes but not limited to transparent glass. With the panel 103 made of the transparent glass, the exhibition is realized, allowing a user to visually observe the remaining number of coffee capsules in the storage drawer 9.

The above descriptions are the preferred solutions of the present disclosure, which show and describe the basic principles, main features and advantages of the present disclosure. Those skilled in the art should understand that the present disclosure is not limited by the embodiments mentioned above. The embodiments and the descriptions mentioned above only illustrate the principles of the present disclosure, there may be various changes and improvements to the present disclosure without departing from the spirit and scope of the present disclosure, such changes and improvements fall within the scope of protection of the present disclosure, and the scope of protection of the present disclosure is defined by the appended claims and equivalents thereof.

What is claimed is:

1. A movable coffee capsule storage rack, comprising a rack body (1) for storage of coffee capsules, wherein a first bracket (11) is fixed to the bottom of the rack body (1), a first caster (2) is rotatably connected to the first bracket (11) through a first rotating shaft (12), a support leg (3) is fixedly connected to the bottom of the rack body (1), the first caster (2) and the support leg (3) are disposed at an interval in the front and rear, for supporting and fixing the rack body (1), a second bracket (53) is disposed adjacent to the support leg (3), a handle (51) is disposed at a first end (531) of the second bracket (53), a second caster (4) is connected to a second end (532) of the second bracket (53), the second bracket (53) between the first end (531) and the second end (532) is rotatably connected to the rack body (1) through a second rotating shaft (55), and when the second bracket (53) is driven to rotate by the handle (51) to drive the second caster (4) to move down to hold up the support leg (3), the rack body (1) are supported by the first caster (2) and the second caster (4) and realizes free sliding.

2. The movable coffee capsule storage rack according to claim 1, wherein a connecting rod (7) is connected to the second end (532) of the second bracket (53), and the second caster (4) is connected to the connecting rod (7).

3. The movable coffee capsule storage rack according to claim 2, wherein the left and right sides of the rack body (1) each are provided with a second bracket (53) and a second caster (4), and the second ends (532) of the two second brackets (53) are coupled by the connecting rod (7), such that the two second brackets (53) form a synchronous structure.

4. The movable coffee capsule storage rack according to claim 1, wherein the first end (531) of the second bracket (53) is bent in an L shape to form the handle (51).

5. The movable coffee capsule storage rack according to claim 2, wherein a connecting rod support plate (54) is fixed to the connecting rod (7), and the second caster (4) is rotatably connected to the connecting rod support plate (54).

6. The movable coffee capsule storage rack according to claim 1, wherein a downswing limit block (6) acting on the second bracket (53) is installed on the rack body (1).

7. The movable coffee capsule storage rack according to claim 1, wherein the bottom of the support leg (3) is provided with an anti-skid pad (8).

8. The movable coffee capsule storage rack according to claim 1, wherein two first casters (2) and two support legs (3) are symmetrically disposed on the left and right sides of the rack body (1).

9. The movable coffee capsule storage rack according to claim 1, wherein the rack body (1) is also internally provided with a storage drawer (9), the left and right outer side walls of the storage drawer (9) are provided with slide rails (901), and rollers (10) slidably matched with the slide rails (901) are correspondingly installed on the front end side of the rack body (1).

10. The movable coffee capsule storage rack according to claim 9, wherein the rack body (1) comprises a frame bottom (101), a support (102) and a panel (103) placed on the support (102), the support leg (3), the first caster (2) and the second bracket (53) are installed on the frame bottom (101), the roller (10) is rotatably connected to the support (102), and the material of the panel (103) is transparent glass.

11. The movable coffee capsule storage rack according to claim 3, wherein a connecting rod support plate (54) is fixed to the connecting rod (7), and the second caster (4) is rotatably connected to the connecting rod support plate (54).
